(19) United States
(12) Patent Application Publication
(10) Pub. No.: US 2024/0326512 A1
(43) Pub. Date: Oct. 3, 2024

(54) OMNIDIRECTIONAL ROLLER WHEEL WITH SOLID BUSHING AND SYMMETRICAL AXLE

(71) Applicant: Lab67 Co., Las Vegas, NV (US)

(72) Inventors: David Bruce McCalib, JR., Ridgefield, WA (US); D. Paul Bennett, Seattle, WA (US)

(73) Assignee: Lab67, Co., Las Vegas, NV (US)

(21) Appl. No.: 18/622,667

(22) Filed: Mar. 29, 2024

Related U.S. Application Data
(60) Provisional application No. 63/492,993, filed on Mar. 29, 2023.

(51) Int. Cl. B60B 19/00; B60B 1/06; B60B 19/12

(52) U.S. Cl. CPC B60B 19/003; B60B 1/06; B60B 19/12; B60B 2310/204; B60B 2320/10

(57) ABSTRACT

A wheel and a method for its manufacture are disclosed herein. The wheel includes a wheel hub including a main axle bore rotatable around a main axis. The wheel also includes a plurality of cross roller sub-assemblies comprising a plurality of pre-roller assemblies. The pre-roller assemblies include a plurality of symmetrical axles, and a plurality of axle bushings, each axle bushing configured to receive one symmetrical axle in a central longitudinal bore. The cross roller sub-assemblies also include a plurality of peripheral rollers, each pre-roller assembly overmolded with one peripheral roller. The wheel also includes a peripheral axle ring adapted about the wheel and radially spaced from the main axis, the wheel having the plurality of cross roller sub-assemblies overmolded with the wheel hub, where the overmolded cross roller sub-assemblies form the peripheral axle ring.

### CROSS-REFERENCE TO RELATED APPLICATIONS

This application claims the benefit of U.S. provisional patent application Ser. No. 63/492,993, filed on Mar. 29, 2023, the contents of which are incorporated herein by reference in their entirety.

### BACKGROUND

Omnidirectional wheels have been in production for many years. Conventional omnidirectional wheels fall into a class of wheels for which there is a main or primary rotational direction around a main axis, with cross rollers added to allow transverse motion (along, rather than around, the main axis). Common examples of such omnidirectional wheels are Mecanum wheels or Rotacasters. In all cases, conventional omnidirectional wheels either rely on split bushings or employ multiple sub-assemblies that are brought together at the final assembly to enclose the enclosure the cross rollers.

These features and methods may necessitate complex, difficult, and time-consuming assembly of smaller parts that may then need to be placed in molds for the overmolding process. Additionally, split or clamshell-style bushings are weaker than solid-style bushings and may lead to failures that might be avoided.

There is, therefore, a need for an omnidirectional wheel design and a manufacturing process that provides the flexible mobility benefits of such a wheel, but that supports more robust construction and more efficient, expeditious, and reliable production.

### BRIEF SUMMARY

In one aspect, a wheel includes a wheel hub including a main axle bore rotatable around a main axis. The wheel also includes a plurality of cross roller sub-assemblies comprising a plurality of pre-roller assemblies. The pre-roller assemblies include a plurality of symmetrical axles, and a plurality of axle bushings, each axle bushing configured to receive one symmetrical axle in a central longitudinal bore. The cross roller sub-assemblies also include a plurality of peripheral rollers, each pre-roller assembly overmolded with one peripheral roller. The wheel also includes a peripheral axle ring adapted about the wheel and radially spaced from the main axis, the wheel having the plurality of cross roller sub-assemblies overmolded with the wheel hub, where the overmolded cross roller sub-assemblies form the peripheral axle ring.

In one aspect, a method of assembling a wheel, includes providing a plurality of pre-roller assemblies including a plurality of symmetrical axles, and a plurality of axle bushings, each axle bushing configured to receive one symmetrical axle in a central longitudinal bore. The method also includes overmolding each axle bushing of the plurality of pre-roller assemblies with a peripheral roller to form a plurality of cross roller sub-assemblies. The method also includes, on condition the cross roller sub-assemblies have been formed, placing, in a mold, each cross roller sub-assembly, the mold configured to form a peripheral axle ring adapted about the wheel and radially spaced from a main axis, and overmolding at least a portion of the cross roller sub-assemblies in the mold with a wheel hub to form the peripheral axle ring, where the wheel hub includes a main axle bore rotatable around the main axis. The method also includes, on condition the cross roller sub-assemblies have not been formed, placing, in the mold, each pre-roller assembly, the mold configured to form a pre-roller peripheral axle ring adapted about the wheel and radially spaced from the main axis, and overmolding the symmetrical axles of the pre-roller assemblies in the mold with the wheel hub to form the pre-roller peripheral axle ring, where the wheel hub includes the main axle bore rotatable around the main axis.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates conventional components and techniques 100 in accordance with one embodiment.

FIG. 2A illustrates an omnidirectional wheel 200a in accordance with one embodiment.

FIG. 2B illustrates an omnidirectional wheel 200b in accordance with one embodiment.

FIG. 3 illustrates omnidirectional wheel movement degrees of freedom 300 in accordance with one embodiment.

FIG. 4A-FIG. 4C illustrate omnidirectional wheel pre-produced components 400 in accordance with one embodiment.

FIG. 5A-FIG. 5C illustrate an omnidirectional wheel assembly flow diagram 500 in accordance with one embodiment.

FIG. 6A illustrates a mold 600a in accordance with one embodiment.

FIG. 6B illustrates a mold 600b in accordance with one embodiment.

FIG. 6C illustrates a mold 600c in accordance with one embodiment.

FIG. 6D illustrates a mold 600d in accordance with one embodiment.

FIG. 7A and FIG. 7B illustrate a peripheral axle ring configuration 700 in accordance with one embodiment.

FIG. 8 illustrates a routine 800 in accordance with one embodiment.

FIG. 9 illustrates exemplary omnidirectional wheel configurations 900 in accordance with one embodiment.

FIG. 10A-FIG. 10C illustrate omnidirectional wheel configuration cross sections 1000 in accordance with one embodiment.

FIG. 11A and FIG. 11B illustrate an omnidirectional wheel in a drop test rig 1100 in accordance with one embodiment.

FIG. 12 illustrates drop test results for a conventional wheel 1200.

FIG. 13 illustrates drop test results for an omnidirectional wheel 1300 in accordance with one embodiment.

### DETAILED DESCRIPTION

The disclosure relates to a new product design that employs a solid bushing, precision assembly, and an advanced overmolding technique used in plastic injection molding, to efficiently produce a robust omnidirectional wheel. It allows for the pre-assembly of symmetrical axles and solid axle bushings into pre-roller assemblies that may then be overmolded into a completed wheel.

This multi-roller omnidirectional wheel may comprise a pre-produced inner wheel hub, pre-produced symmetrical axles (also referred to as axles, roller pins, cross symmetrical axles, or cross roller pins), pre-produced solid axle bushings, polyurethane peripheral rollers overmolded onto the axle bushings, an overmolded wheel hub, and in one embodiment a pre-produced inner wheel hub.

The symmetrical axle may be made of metal or may be extruded or molded from plastic materials. In one embodiment, the symmetrical axle may be linearly symmetrical around a midline normal to its rotational axis, in addition to having rotational symmetry around that axis. (I.e., an elevation or plan view of the long side of such a symmetrical axle may show that the two halves on either side of the midpoint are either identical or mirror images, in contrast to asymmetrical axles for which the two halves on either side of the midline have different geometry or features.)

The solid axle bushings may be extruded, molded, or otherwise produced before wheel assembly. Alignment features may be configured to maintain the symmetrical axle in a centered position with respect to the axle bushing.

During the pre-assembly process into the mold, the symmetrical axles and axle bushings may be assembled together and then overmolded with polyurethane peripheral rollers. These cross roller sub-assemblies may then be placed into a mold along with the inner wheel hub where one is provided. Some of the positional tolerance may be taken up by the urethane wheel. During the final overmold, shut-off regions may be presented to prevent the overmolded plastic from interfering with the symmetrical axles, axle bushings, and/or polyurethane peripheral rollers.

The process of overmolding polyurethane peripheral rollers to the symmetrical axles and axle bushings may also be performed in an alternative sequence. The symmetrical axles and axle bushings may first be assembled into pre-roller assemblies. These pre-roller assemblies may be organized and placed into a mold for a desired number of peripheral rollers. A wheel hub may then be injection overmolded, enclosing the pre-roller assemblies. Finally, the polyurethane peripheral rollers may be overmolded onto the pre-roller assemblies.

In one embodiment, the peripheral rollers may be overmolded onto the axle bushings. A mold may be developed that accepts the peripheral roller and axle bushing units and allows for the overmolding of the symmetrical axles in place and in connection with the wheel hub, which may be molded separately or at the same time as the symmetrical axles.

The configuration and techniques disclosed herein may provide a much stronger wheel design and may support quicker, simpler automated manufacturing and assembly of the disclosed omnidirectional wheel. It solves the problem of needing to assemble a split bushing onto a plastic hub over a roller pin axle and the subsequent need for a challenging overmold technique in the final molding operation. This disclosure allows for the difficult-to-manufacture parts to be made separately, along with one final overmold technique that would allow the hub to be overmolded rather than the polyurethane bushing.

The advantages and improvements of this disclosure include the greater strength of the composite wheel and the ability to fully automate the process through the use of simple automation sortation tooling. While full automation may not be needed from the creation of the primary parts to finished composite part manufacturing, the disclosed solution provides a scall-invariant product design and greatly facilitates the application of automation and closed-loop control of the assembly. This disclosure greatly simplifies assembly by reducing the complexity of each individual part and subassembly and by employing overmolding to join all of the wheel components, essentially potting them together.

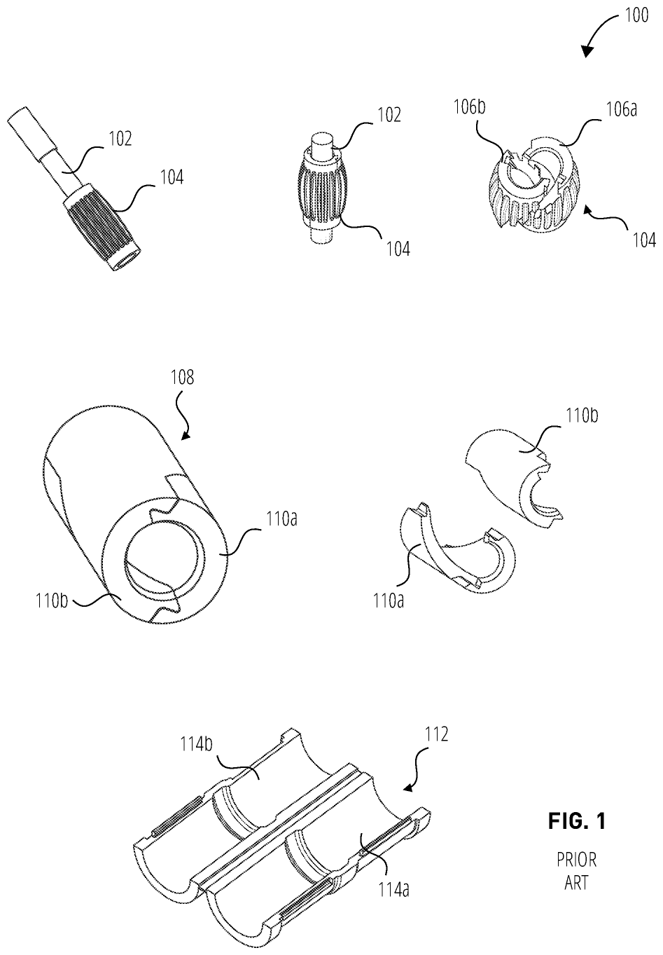

FIG. 1 illustrates conventional components and techniques 100 in accordance with one embodiment. First, a hub or axle 102 may be injection molded in its final form. Then the separate components of bushings such as the split bushing with a spherical outer diameter 104, split bushing with a cylindrical outer diameter 108, or clamshell bushing 112, may be injection molded. The component part 106a and component part 106b of the split bushing with a spherical outer diameter 104, the identical component half 110a and identical component half 110b of the split bushing with a cylindrical outer diameter 108, or the joined half 114a and the joined half 114b of the clamshell bushing 112 may next be clipped, snapped, or otherwise connected or engaged around the axle 102 or hub. The axle/bushing sub-assemblies may then be inserted into an overmolding process where the polyurethane cross rollers are processed. One wheel or multiple wheels joined together may create a conventional omnidirectional wheel assembly.

Existing products may use such clamshell bushings or split bushings to provide the bearing surface between a polyurethane cross roller and hub or axle. Under extreme loading conditions, split- or clamshell-style bushings may exhibit weakness in compressive loading due to their split lines and non-homogeneous material. Additionally, two parts must be made separately and then assembled for such bushings, making them more complex parts to manufacture and assemble.

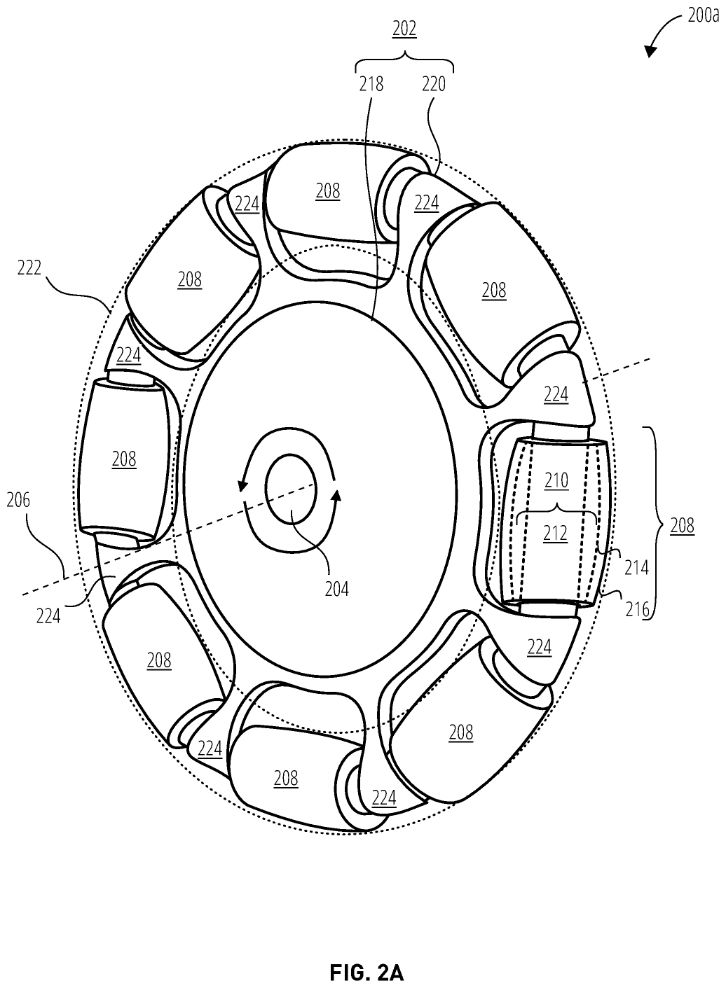

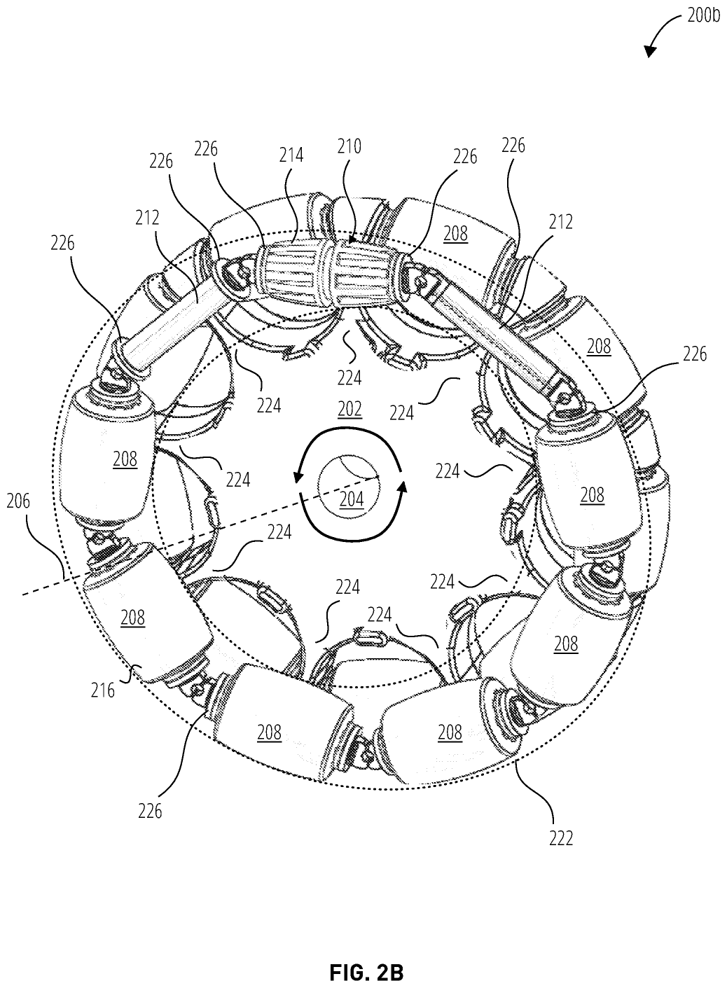

FIG. 2A illustrates an omnidirectional wheel 200a in accordance with one embodiment. The omnidirectional wheel 200a comprises a wheel hub 202 having a main axle bore 204 and a main axis 206, cross roller sub-assemblies 208 that include pre-roller assemblies 210 each comprising a symmetrical axle 212 and an axle bushing 214, and a peripheral roller 216, the wheel hub 202 comprising an inner wheel hub 218 and an outer wheel hub 220, a peripheral axle ring 222, and spokes 224 of the wheel hub 202.

The omnidirectional wheel 200a may have a wheel hub 202 that includes a main axle bore 204 at its center, rotatable around a main axis 206. The periphery of the wheel hub 202 may include a plurality of cross roller sub-assemblies 208. The cross roller sub-assemblies 208 may each include a pre-roller assembly 210 comprising a symmetrical axle 212 and an axle bushing 214. Each axle bushing 214 may be configured to receive one symmetrical axle 212 in a central longitudinal bore. The symmetrical axles 212 and axle bushings 214 may be pre-produced parts. They may be injection molded from plastic materials. The symmetrical axles 212 may be formed from metal in one embodiment. The cross roller sub-assemblies 208 may each further include a peripheral roller 216. Each pre-roller assembly 210 may be overmolded with its peripheral roller 216.

In one embodiment, the wheel hub 202 may comprise an inner wheel hub 218 and an outer wheel hub 220. The inner wheel hub 218 may be a pre-produced part, constructed of injection molded plastic materials. The outer wheel hub 220 may be overmolded onto the inner wheel hub 218 and pre-roller assemblies 210 or cross roller sub-assemblies 208 as described herein. The wheel hub 202, and/or in one embodiment the outer wheel hub, may comprise a plurality of spokes 224. Each cross roller sub-assembly 208 may be secured between two spokes of the overmolded wheel hub (i.e., the wheel hub 202 or outer wheel hub 220).

In this manner, a peripheral axle ring 222 adapted about the wheel and radially spaced from the main axis 206 may be formed, the omnidirectional wheel 200a having the plurality of cross roller sub-assemblies 208 overmolded with the wheel hub 202, to form the peripheral axle ring 222.

FIG. 2B illustrates an omnidirectional wheel 200b in accordance with one embodiment. The omnidirectional wheel 200b comprises a wheel hub 202 having a main axle bore 204 and a main axis 206, cross roller sub-assemblies 208 that include pre-roller assemblies 210 each comprising a symmetrical axle 212, an axle bushing 214, and two washers 226, and a peripheral roller 216, the wheel hub 202 comprising spokes 224, and the cross roller sub-assemblies 208 forming a peripheral axle ring 222.

The omnidirectional wheel 200b may have a wheel hub 202 that includes a main axle bore 204 at its center, rotatable around a main axis 206. The periphery of the wheel hub 202 may include a plurality of cross roller sub-assemblies 208. The cross roller sub-assemblies 208 may each include a pre-roller assembly 210 comprising a symmetrical axle 212, an axle bushing 214, and two washers 226. Each axle bushing 214 may be configured to receive one symmetrical axle 212 in a central longitudinal bore. The symmetrical axles 212 and axle bushings 214 may be pre-produced parts. They may be injection molded from plastic materials. The symmetrical axles 212 may be formed from metal in one embodiment. The washers 226 may be disposed upon both ends of the assembled symmetrical axles 212 and axle bushings 214. The cross roller sub-assemblies 208 may each further include a peripheral roller 216. Each pre-roller assembly 210 may be overmolded with its peripheral roller 216.

The wheel hub 202 may comprise a plurality of spokes 224. Each cross roller sub-assembly 208 may be secured between two spokes of the overmolded wheel hub 202. In this manner, a peripheral axle ring 222 adapted about the wheel and radially spaced from the main axis 206 may be formed, the omnidirectional wheel 200a having the plurality of cross roller sub-assemblies 208 overmolded with the wheel hub 202, to form the peripheral axle ring 222.

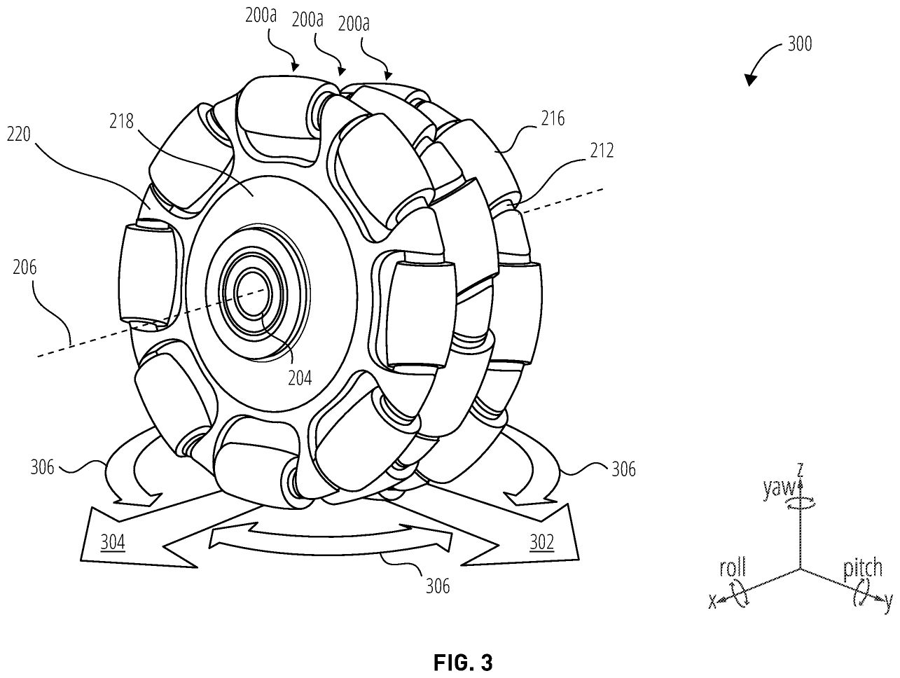

FIG. 3 illustrates omnidirectional wheel movement degrees of freedom 300 in accordance with one embodiment. The omnidirectional wheels 200a may roll in an in-line motion 302 as conventional wheels do, in a roll rotation around the main axis 206 that runs through the center of the main axle bore 204. However, if in-line motion 302 of the wheel hub 202 around the main axis 206 is arrested, or the desired movement of equipment configured with the omnidirectional wheels 200a is perpendicular to the in-line motion 302, the omnidirectional wheels 200a may also be capable of side-to-side or transverse motion 304, due to the pitch rotation of the cross roller sub-assemblies 208 of the peripheral axle ring 222 configured along the perimeter of the inner wheel hub 218.

Note that the omnidirectional wheels 200a disclosed herein may be prevented from moving in a swivel motion 306 (yaw rotation) to allow quicker and more secure stacking of equipment configured with such wheels. The primary benefit of omnidirectional wheels 200a may be their maneuverability in tight spaces, even when swivel motion 306 is prevented.

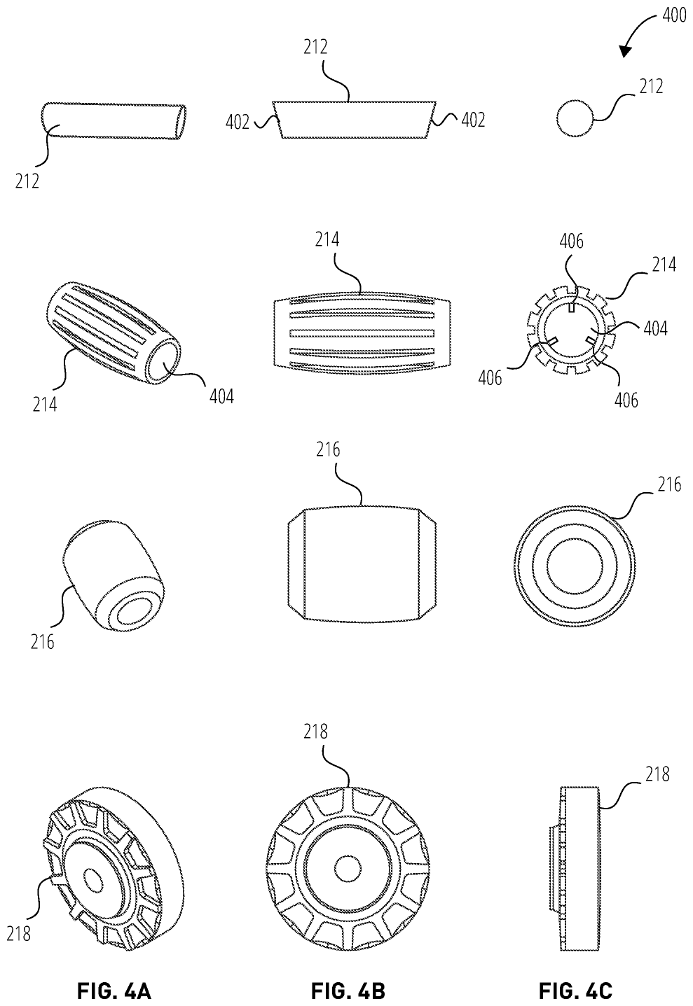

FIG. 4A-FIG. 4C illustrate omnidirectional wheel pre-produced components 400 in accordance with one embodiment. FIG. 4A provides isometric views of the omnidirectional wheel pre-produced components 400, FIG. 4B provides front elevation views, and FIG. 4C provides side elevation views. The omnidirectional wheel pre-produced components 400 may comprise the symmetrical axles 212, axle bushings 214, peripheral rollers 216, and inner wheel hub 218 introduced in FIG. 2A.

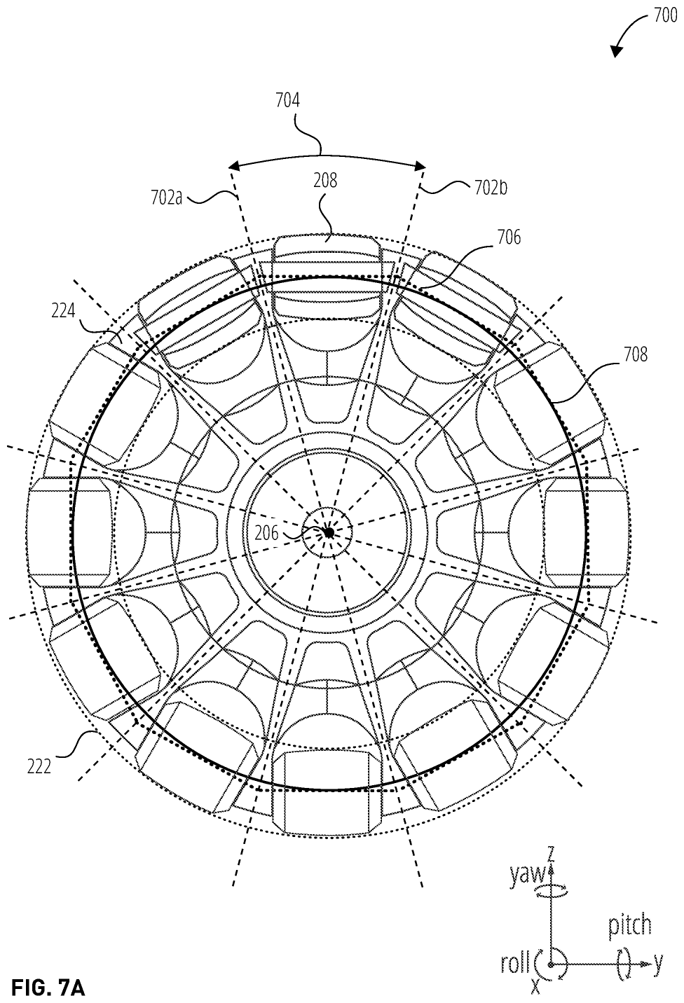

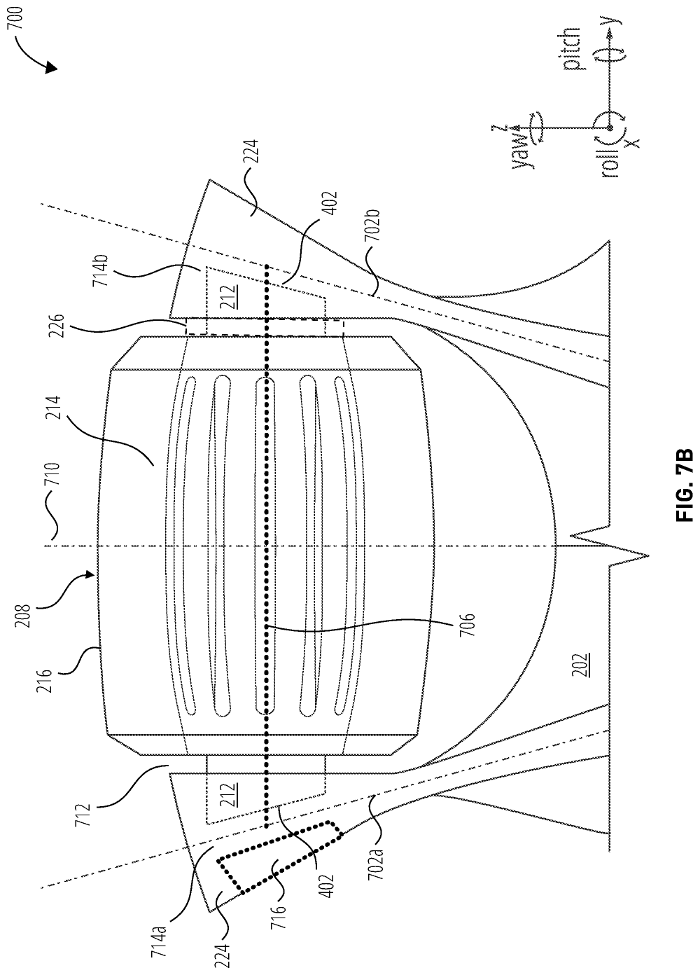

In one embodiment, the symmetrical axles 212 may have chamfered sides 402 which are symmetrical across a midline normal to their axis of rotation. This is illustrated in greater detail in FIG. 7A and FIG. 7B. The axle bushing 214 may include a central longitudinal bore 404 configured to accept the symmetrical axle 212. As may be seen readily in the symmetrical axle 212 and axle bushing 214 of FIG. 4C, the central longitudinal bore 404 of the axle bushing 214 may have an inner diameter that is slightly larger than the outer diameter of the symmetrical axle 212.

The central longitudinal bore 404 may additionally include alignment features 406 to maintain the symmetrical axle 212 centered within the central longitudinal bore 404, such that the symmetrical axle 212 and the axle bushing 214 may be maintained coaxial with each other, and with respect to their cross roller sub-assembly axis of rotation as part of the peripheral axle ring 222. In one embodiment, the alignment features 406 may be additionally configured to maintain the symmetrical axle 212 and axle bushing 214 centered along a common midline normal to their axes of rotation. This geometry is illustrated in greater detail with respect to FIG. 7A and FIG. 7B. Such features may include low-friction protrusions within the central longitudinal bore 404 as shown by the alignment features 406 illustrated, or may be formed through other techniques that will be readily apprehended by one of ordinary skill in the art.

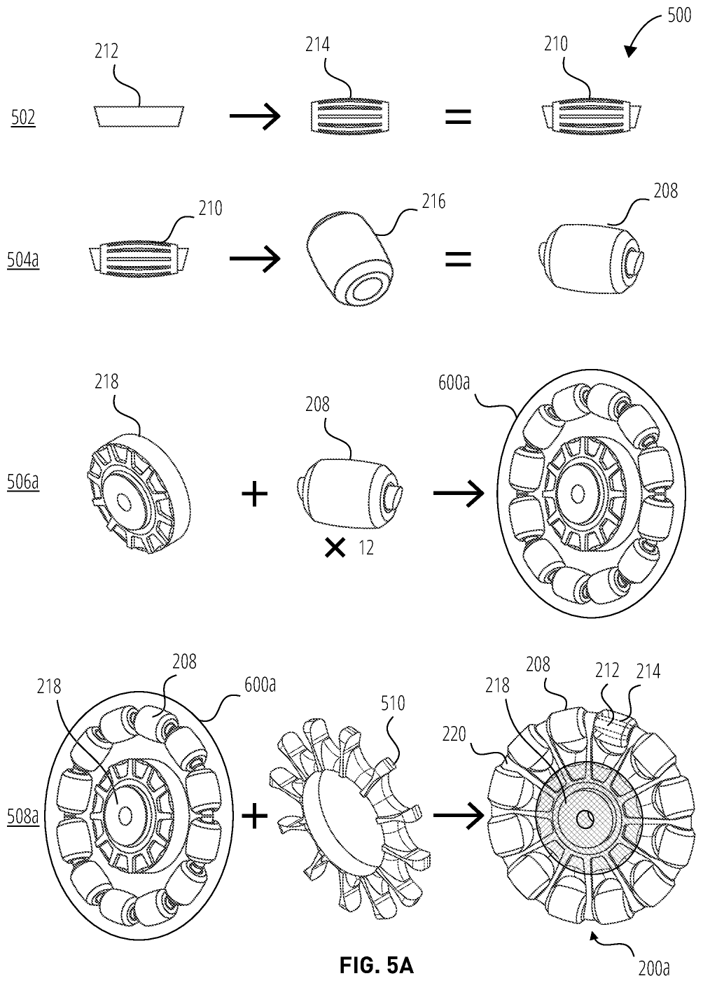

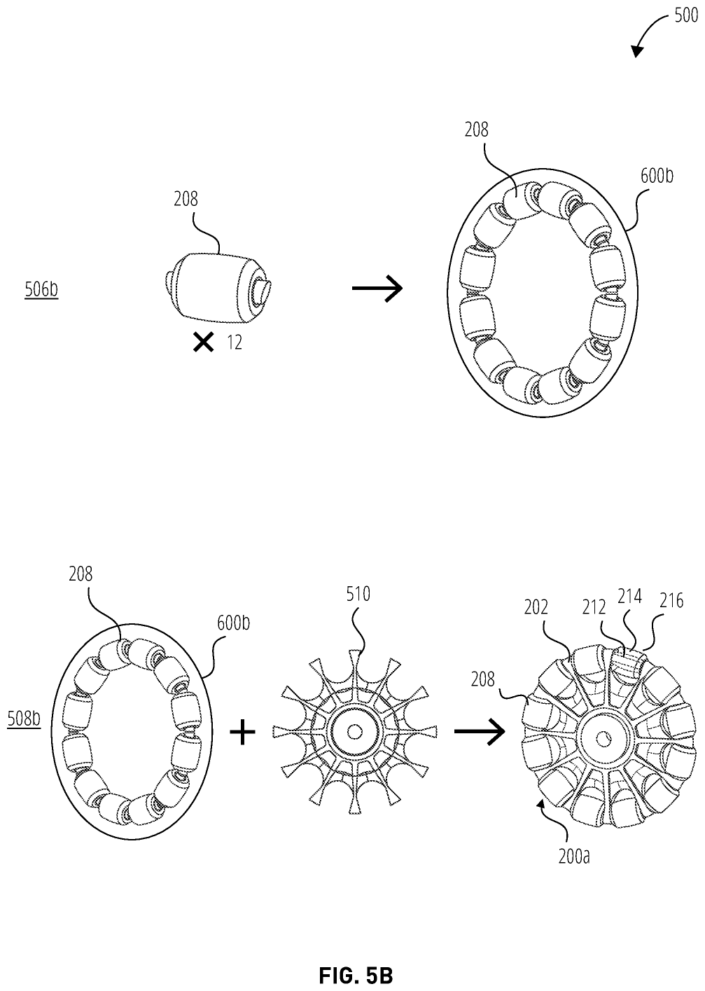

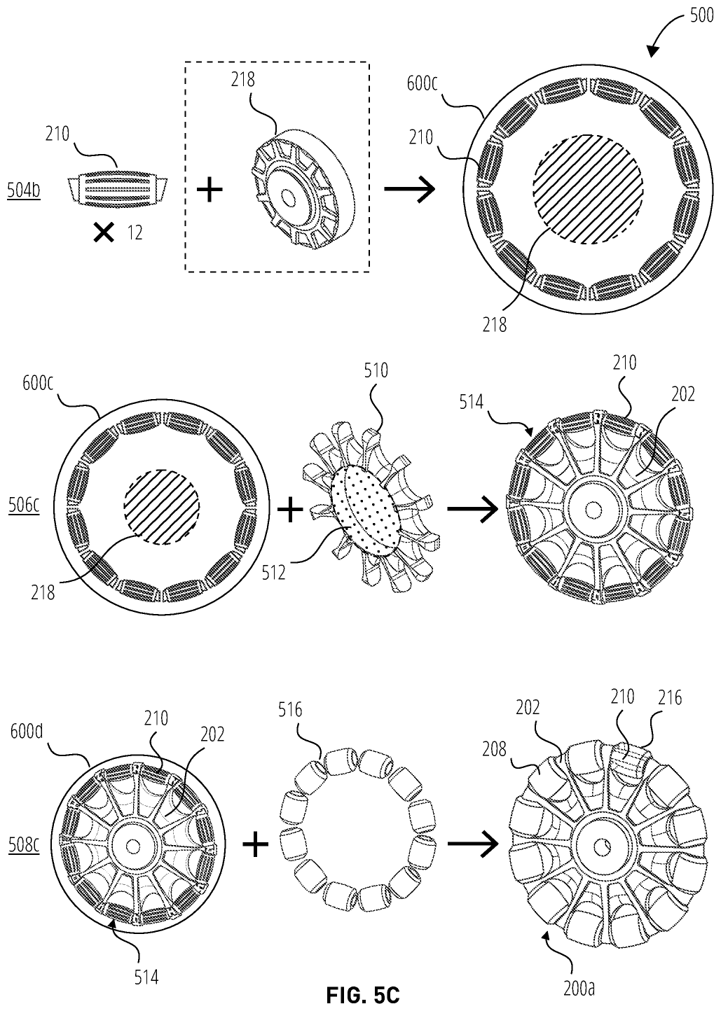

FIG. 5A-FIG. 5C illustrate an omnidirectional wheel assembly flow diagram 500 in accordance with one embodiment. The omnidirectional wheel pre-produced components 400 may be assembled as shown to form the omnidirectional wheel 200a.

Symmetrical axles 212 may be inserted into axle bushings 214 to form pre-roller assemblies 210 at step 502. The pre-roller assemblies 210 together may be overmolded to form peripheral rollers 216 and complete the cross roller sub-assemblies 208 at step 504a.

The inner wheel hub 218 and a number of the cross roller sub-assemblies 208, such as the twelve cross roller sub-assemblies 208 shown, may be placed in a mold 600a at step 506a. It will be readily understood by one of ordinary skill in the art that differing sizes of omnidirectional wheels 200a may utilize more or fewer cross roller sub-assemblies 208. While the illustrated example uses twelve cross roller sub-assembly 208, an omnidirectional wheel 200a may use four, five, six, eight, sixteen, or a variety of other cross roller sub-assembly 208 quantities as needed for the desired final design.

The outer wheel hub 220 may then be overmolded around and among the omnidirectional wheel pre-produced components 400 at step 508a. The wheel hub overmolding volume 510 may flow into the mold 600a to form the spokes of the outer wheel hub 220, each spoke encapsulating the ends of the symmetrical axles 212 of the cross roller sub-assemblies 208 to either side of it. In this manner, the peripheral axle ring may be formed, with the cross roller sub-assemblies 208 each centered between the spokes of the outer wheel hub 220 to create the finished omnidirectional wheel 200a.

Alternatively, the cross roller sub-assemblies 208 created in step 504a may be placed in a mold 600b in step 506b, with no pre-produced inner wheel hub 218. This is illustrated in FIG. 5B. In such an embodiment, the wheel hub overmolding volume 510 may be molded into a solid, single-part wheel hub overmolding volume 510 within and among the cross roller sub-assemblies 208 in step 508b to create the finished omnidirectional wheel 200a.

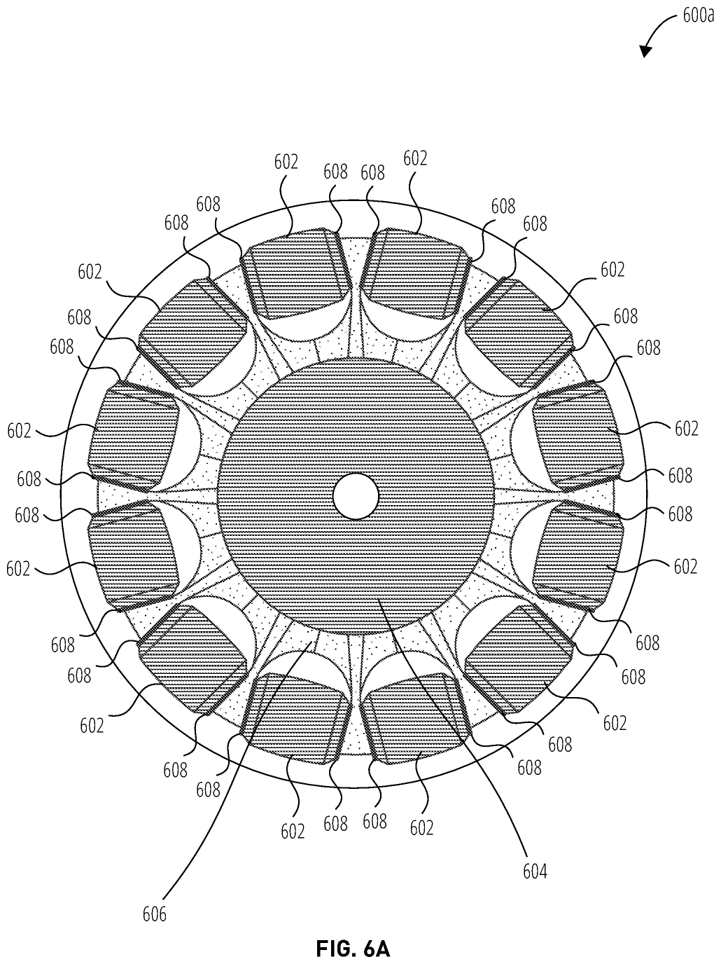

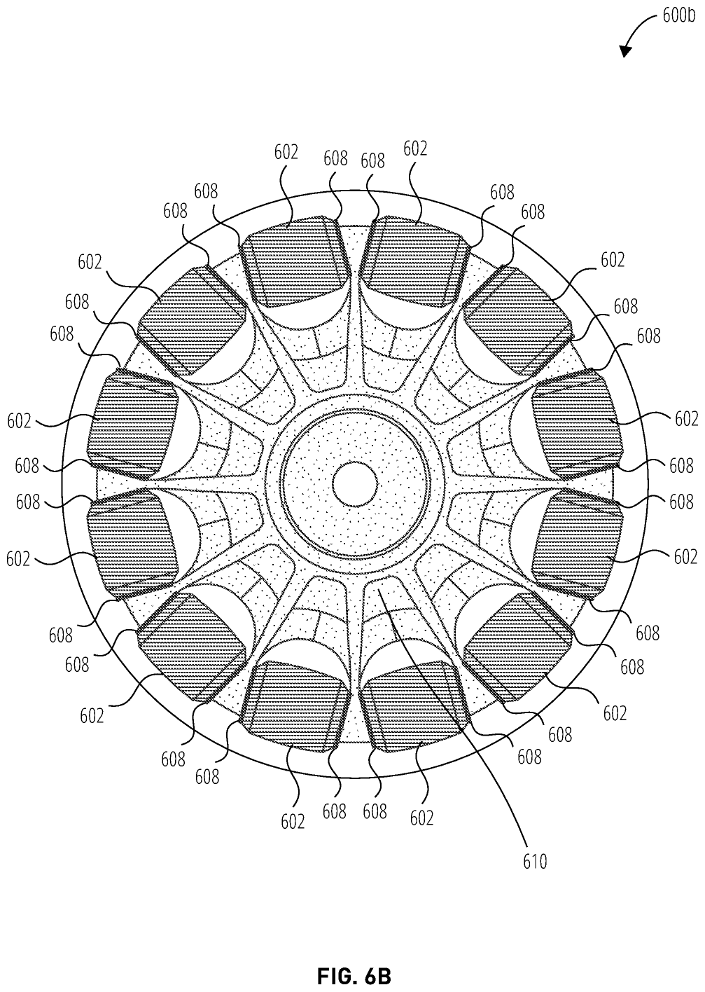

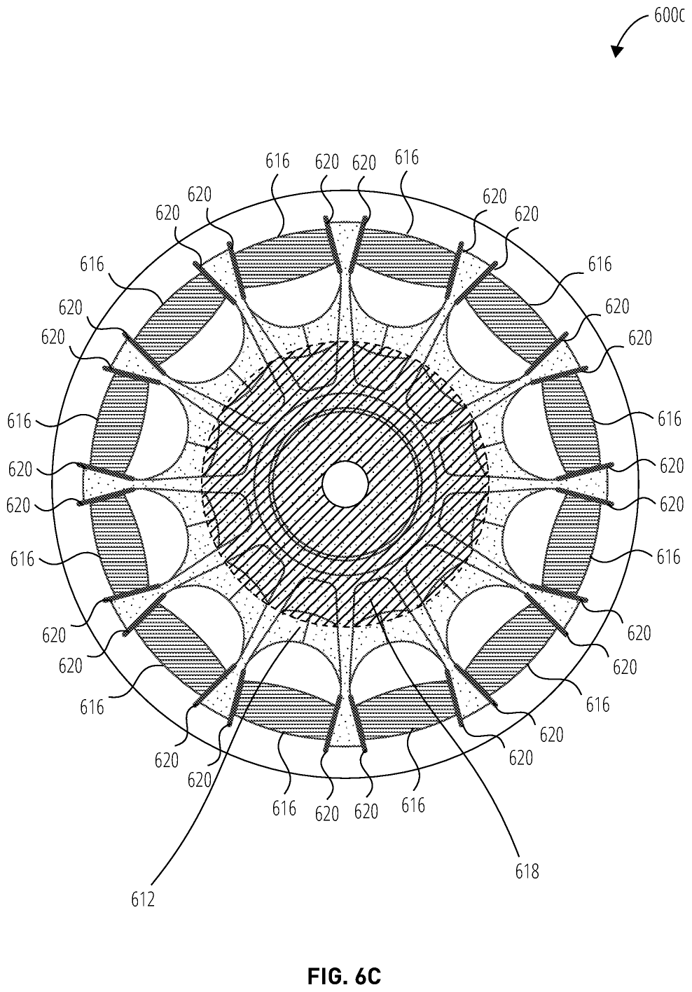

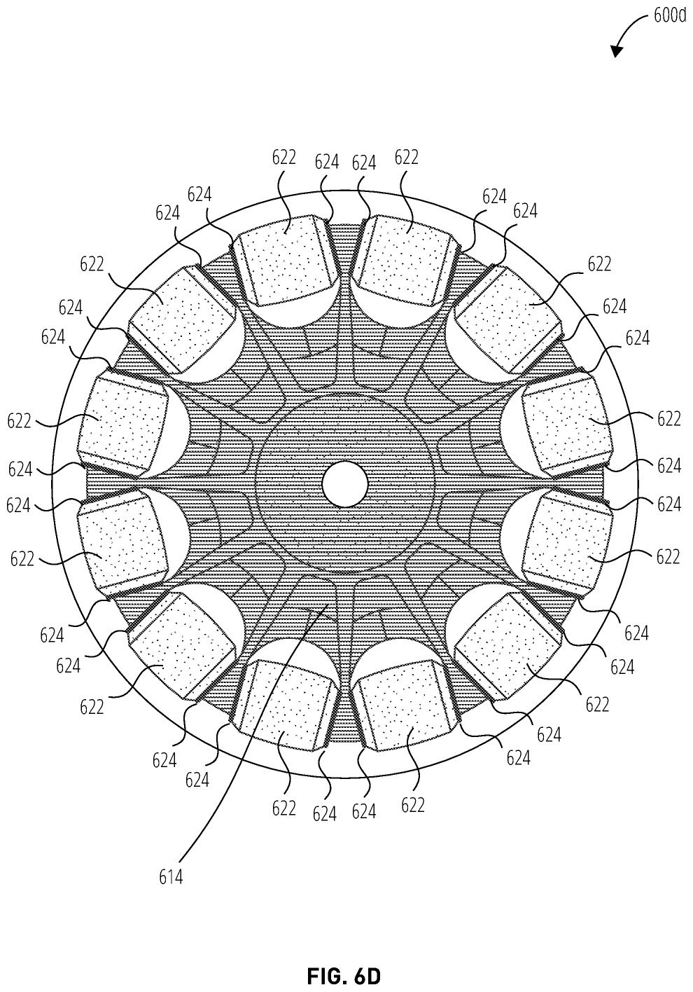

In each case above, the cross roller sub-assemblies 208 may be carefully aligned in the molds and may have overmolding shutout regions present such as those shown for mold 600a and mold 600b in FIG. 6A and FIG. 6B. This may produce an overmolded outer wheel hub 220 or wheel hub overmolding volume 510 that securely captures the ends of the symmetrical axles 212 while still permitting rotation of the peripheral rollers 216 and axle bushings 214.

As an additional alternative, the desired number of pre-roller assemblies 210 created in step 502 may be placed into mold 600c without yet being overmolded with their peripheral rollers in step 504b, shown in FIG. 5C. Optionally, an inner wheel hub 218 may be placed into an embodiment of mold 600c configured to accommodate this component.

In step 506c, a wheel hub overmolding volume 510, which may include an optional inner overmolding fill 512 where an inner wheel hub 218 is not present in mold 600c, may be overmolded within mold 600c to form a pre-roller peripheral axle ring 514 around and connected to a wheel hub 202. The wheel hub 202 and pre-roller peripheral axle ring 514 may in step 508c be placed in a mold 600d, as illustrated in FIG. 6D. A peripheral roller overmolding volume 516 may then be overmolded to form the cross roller sub-assemblies 208 enclosed in the wheel hub 202 to form the omnidirectional wheel 200a as shown.

FIG. 6A illustrates a mold 600a in accordance with one embodiment. The mold 600a may include seats for cross roller sub-assemblies 602, a seat for an inner wheel hub 604, an outer wheel hub overmolding volume 606, and shut-off regions 608.

Each seat for a cross roller sub-assembly 602 may accept a cross roller sub-assembly 208 assembled as described with respect to step 506a illustrated in FIG. 5A. The seat for an inner wheel hub 604 may accept the pre-produced inner wheel hub 218 introduced in FIG. 2A.

While one half of the mold 600a is illustrated herein, it will be readily understood by one of ordinary skill in the art that an additional, covering half, incorporating appropriate seats for cross roller sub-assemblies 602, seat for an inner wheel hub 604, and outer wheel hub overmolding volume 606 may be placed above the half shown, enclosing the cross roller sub-assemblies 208, the inner wheel hub 218, and the entire depth of the outer wheel hub overmolding volume 606. In some embodiments, the two halves may be symmetrical. In other embodiments, one half may include profile differences from its mate that accommodate design asymmetrics in the pre-produced components and/or the intended outer wheel hub 220.

During the overmolding process, the outer wheel hub overmolding volume 606 may be filled with the selected overmolding material, and may securely capture the inner wheel hub 218 and the symmetrical axles 212 of the cross roller sub-assemblies 208. Shut-off regions 608 may be presented during the overmolding process such that an overmolding material does not interfere with at least one of the symmetrical axles 212, axle bushings 214, and peripheral rollers 216 of the cross roller sub-assemblies 208 introduced in FIG. 2A.

In one embodiment, the shut-off regions 608 may prevent the overmolding material from interfering with the symmetrical axles 212. In another embodiment, the shut-off regions 608 may prevent interference of overmolding material with the axle bushings 214. In another embodiment, the shut-off region 608 may prevent interference of overmolding material with the peripheral rollers 216. Other embodiments may incorporate shut-off regions 608 that prevent interference of overmolding material with any combination of these components. In embodiments wherein the pre-roller assemblies 210 include washers 226, the shut-off regions 608 may incorporate the washers 226 or may be configured to prevent interference of overmolding material with the washers 226.

For example, in one embodiment, the shut-off regions 608 may prevent interference of overmolding material with the pre-roller assemblies 210 introduced in FIG. 2A (i.e., the symmetrical axles 212 and axle bushings 214 assembled together). In another embodiment, the shut-off regions 608 may prevent interference of the overmolding material with the axle bushings 214 and overmolded peripheral rollers 216. In another embodiment, the shut-off regions 608 may prevent the overmolding material from interfering with any components of the cross roller sub-assemblies 208 (i.e., shutting out all of the symmetrical axles 212, axle bushings 214, and peripheral rollers 216).

FIG. 6B illustrates a mold 600b in accordance with one embodiment. The mold 600b may include seats for cross roller sub-assemblies 602 and shut-off regions 608 similar to those described for the mold 600a of FIG. 6A. However, the mold 600b may omit the seat for an inner wheel hub 604, and may include a wheel hub overmolding volume 610 supporting the formation of a solid, single-piece wheel hub overmolding volume 510 as described with respect to steps 506b and 508b illustrated in FIG. 5B. As described with respect to the mold 600a, an overlying half of the mold 600b, while not illustrated, may be understood to be provided, either symmetrical in profile with the mold 600b shown or differing in profile.

It may be well understood by one of ordinary skill in the art that, while the mold configurations illustrated herein are shown as separate molds for simplicity, a single mold may be used incorporating the features and capabilities of both mold 600a and mold 600b. The inner wheel hub may have the same profile as is desired for the corresponding portion of a single-piece overmolded wheel hub, and so a pre-produced inner wheel hub may be seated in a mold that is also suitable for forming a single-piece overmolded wheel hub, the process difference being the amount of overmold material used. Similarly, a single mold may have a portion accepting inserts that form, accommodate, or mask features desired to be varied among wheel designs.

FIG. 6C illustrates a mold 600c in accordance with one embodiment. The mold 600c may include seats for pre-roller assemblies 616, and in one embodiment may include an optional seat for an inner wheel hub 618, which may be placed in the mold 600c as shown with respect to step 506c, illustrated in FIG. 5C. The mold 600c may also include a wheel hub overmolding volume 612 which may include or exclude a volume otherwise occupied by the inner wheel hub, as appropriate to the desired design.

First shut-off regions 620 may be provided as shown, such that the symmetrical axles of each pre-roller assembly may be overmolded with the wheel hub overmolding volume 612 while the overmolding material may be prevented from interfering with at least one of the symmetrical axles and the axle bushings of the pre-roller assemblies. In one embodiment, the first shut-off regions 620 may prevent interference of overmolding material with the symmetrical axles. In one embodiment, the first shut-off regions 620 may prevent interference of overmolding material with the axle bushings. In one embodiment, the first shut-off regions 620 may prevent interference of overmolding material with both the symmetrical axles and the axle bushings. In embodiments wherein the pre-roller assemblies 210 include washers 226, the first shut-off regions 620 may incorporate the washers 226 or may be configured to prevent interference of overmolding material with the washers 226.

As described with respect to the mold 600a, an overlying half of the mold 600c, while not illustrated, may be understood to be provided, either symmetrical in profile with the mold 600c shown or differing in profile.

FIG. 6D illustrates a mold 600d in accordance with one embodiment. The mold 600d may include a seat for an overmolded wheel hub and pre-roller assemblies 614, configured to accept the pre-roller peripheral axle ring and wheel hub as shown in step 508c of FIG. 5C. The mold 600d may further include peripheral roller overmolding volumes 622 such that the peripheral rollers may be overmolded onto the pre-roller assemblies.

Second shut-off regions 624 may be provided as shown, such that the overmolding material of the peripheral roller overmolding volume 622 may be molded onto the axle bushings of the pre-roller assembly 210 to form the peripheral rollers without interfering with the symmetrical axles or the spokes of the wheel hub. In another embodiment, the second shut-off regions 624 may prevent interference of the overmolding material with the wheel hub, the symmetrical axles, and the axle bushings. In embodiments wherein the pre-roller assemblies 210 include washers 226, the second shut-off regions 624 may incorporate the washers 226 or may be configured to prevent interference of overmolding material with the washers 226.

As described with respect to the mold 600a, an overlying half of the mold 600d, while not illustrated, may be understood to be provided, either symmetrical in profile with the mold 600d shown or differing in profile.

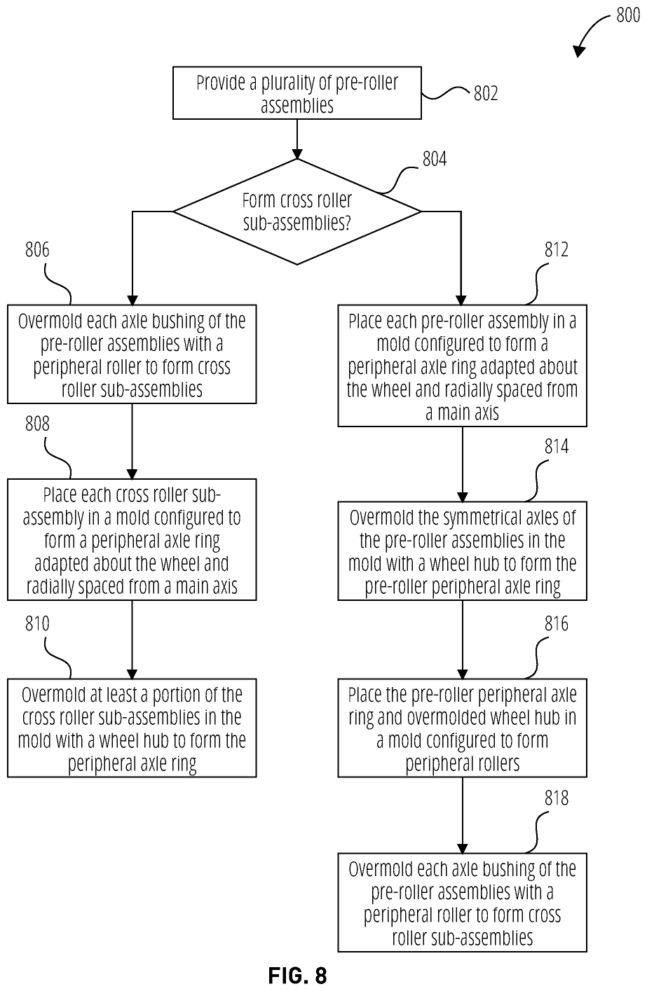

In one embodiment, the mold 600c may be a first mold used during a process or routine for manufacturing the omnidirectional wheel 200a, such as is illustrated by the omnidirectional wheel assembly flow diagram 500 of FIG. 5A-FIG. 5C and/or the routine 800 of FIG. 8, and the mold 600d may be a second mold used during a later step of that process or routine. It may be well understood by one of ordinary skill in the art, however, that, while the mold configurations illustrated herein are shown as separate molds for simplicity, a single mold may be used incorporating the features and capabilities of both mold 600c and mold 600d. The inner wheel hub may have the same profile as is desired for the corresponding portion of a single-piece overmolded wheel hub, and so a pre-produced inner wheel hub may be seated in a mold that is also suitable for forming a single-piece overmolded wheel hub, the process difference being the amount of overmold material used.

Similarly, a single mold may have a portion accepting inserts that form, accommodate, or mask features desired to be varied among wheel designs. Thus, one mold may be configured to accept an insert allowing the pre-roller assemblies to seat and having suitable shut-off regions and overmolding volume for molding the wheel hub. The underlying mold may, when such an insert is removed, include seating, shut-off regions, and overmolding volumes suitable for overmolding the peripheral rollers. The configurations shown in FIG. 6A-FIG. 6D are intended to illustrate exemplary molds for use in the disclosed methods, but other configurations will immediately present themselves to one of ordinary skill in the art.

FIG. 7A and FIG. 7B illustrate a peripheral axle ring configuration 700 in accordance with one embodiment. FIG. 7A shows the entirety of the peripheral axle ring 222 and FIG. 7B shows a detailed view centered on the topmost cross roller sub-assembly 208, which may be considered representative of all cross roller sub-assemblies 208 configured in the peripheral axle ring 222.

The dashed lines in FIG. 7A show the wheel hub spoke bisectors, such as wheel hub spoke bisector 702a and wheel hub spoke bisector 702b. The wheel hub spoke bisectors are geometric lines that each run through the main axis 206 and divide each spoke 224 in half. Adjacent wheel hub spoke bisectors, such as wheel hub spoke bisector 702a and wheel hub spoke bisector 702b, may meet at the main axis 206 to form a central angle 704. The central angle 704 may be measured in degrees and may be determined by dividing the full 360 degrees of the wheel hub by the number of spokes 224. In the example illustrated, the twelve spokes of the wheel hubs 202 divide the 360 degrees of the wheel hub 202 periphery by twelve, giving a central angle 704, as defined by wheel hub spoke bisector 702a and wheel hub spoke bisector 702b, of 30 degrees.

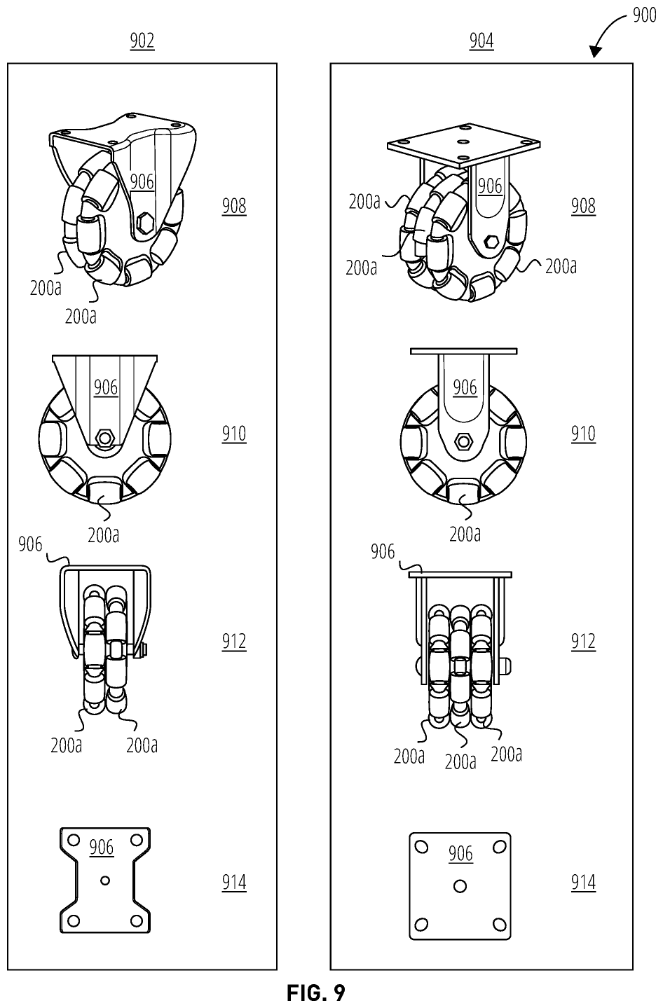

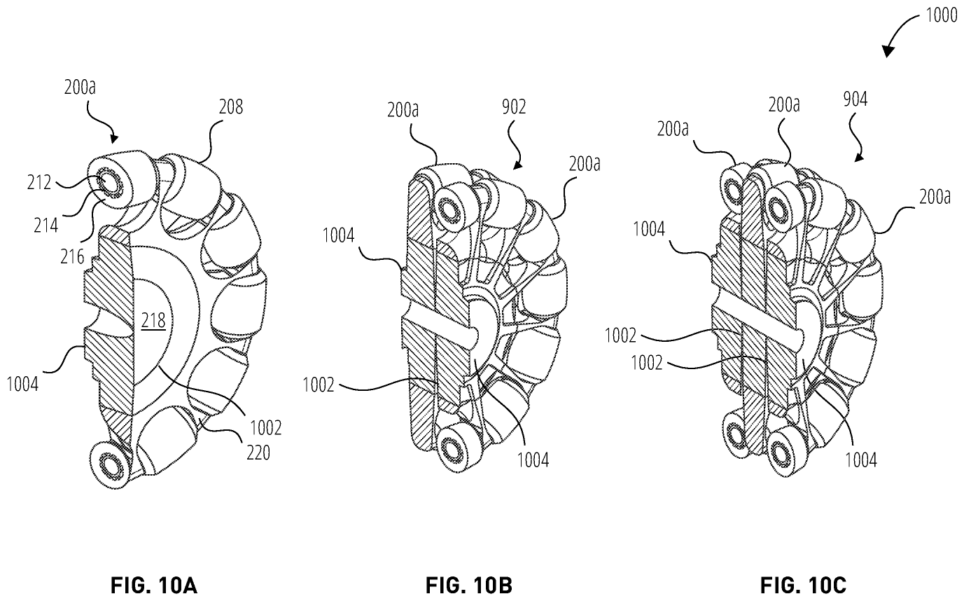

Each cross roller sub-assembly 208 may have a cross roller sub-assembly axis of rotation 706. The cross roller sub-assembly axis of rotation 706 may be colinear with a latitudinal midline of the symmetrical axle 212 of the cross roller sub-assembly 208, as shown by the heavier dotted lines that bisect each cross roller sub-assembly 208 illustrated in FIG. 7A. The cross roller sub-assembly axes of rotation 706 may tangentially define a pitch circle 708 of the peripheral axle ring 222, depicted here with a heavy solid line. This pitch circle 708 may be centered on the main axis 206 and may provide a continuous rotational axis in support of the rotational motion about the y-axis (pitch), normal to roll rotation about the main axis 206 in the x dimension. This in turn provides the transverse motion 304 illustrated in FIG. 3, regardless of the orientation of the cross roller sub-assemblies 208 with respect to a surface of movement (e.g., a floor or ground surface). This may be seen in particular with regard to the double omnidirectional wheels 902 and triple omnidirectional wheels 904 discussed below with respect to FIG. 9-FIG. 10C.

In FIG. 7B, a cross roller sub-assembly 208 is shown in detail secured between spokes 224 of the wheel hub 202 previously introduced. The components of the cross roller sub-assembly 208 (i.e., the symmetrical axle 212, axle bushing 214, and peripheral roller 216) may be centered in the z dimension (and in the x dimension, though this is not shown) at the cross roller sub-assembly axis of rotation 706, and may be centered in the y dimension at a cross roller sub-assembly midline 710. The cross roller sub-assembly midline 710 may be considered as the geometrical line dividing the cross roller sub-assembly 208 in half longitudinally. The cross roller sub-assembly midline 710 may be a bisector of the central angle 704 formed by the wheel hub spoke bisector 702a and wheel hub spoke bisector 702b at the main axis 206. Thus, within a reasonable manufacturing tolerance, the cross roller sub-assemblies 208 of a completed omnidirectional wheel 200a may be considered as being centered between adjacent spokes 224 of the wheel hub 202.

The shut-off regions 608, first shut-off regions 620, and/or second shut-off regions 624 of FIG. 6A-FIG. 6D may provide a gap 712 between each spoke 224 and the side of the adjacent cross roller sub-assembly 208. In this manner, the wheel hub 202 may securely capture the symmetrical axle 212 while allowing the peripheral roller 216 and axle bushing 214 to roll freely. In one embodiment, where washers 226 are included in the pre-roller assemblies 210, the washers 226 may inhabit this gap as illustrated herein. The overmolding of the wheel hub 202 may be performed with shut-off regions that prevent impingement of the overmold material upon the washers 226, or the washers 226 may act to shut off material from interfering with the symmetrical axle 212, the axle bushing 214, and/or the peripheral roller 216 of the cross roller sub-assembly 208.

The cross roller sub-assembly 208 may be dimensioned and disposed such that the chamfered side 402 of the symmetrical axle 212 may be aligned with the wheel hub spoke bisector 702a as shown while providing clearance 714a to prevent interference between the symmetrical axle 212 of the cross roller sub-assembly 208 and an adjacent symmetrical axle of an adjacent cross roller sub-assembly 716. Similarly, the opposite chamfered side 402 may be aligned with the wheel hub spoke bisector 702b while providing clearance 714b. These clearances between the chamfered sides 402 of the symmetrical axle 212 and the corresponding chamfered sides 402 of adjacent symmetrical axles of adjacent cross roller sub-assemblies 716 may be uniform along their lengths in alignment with their intervening wheel hub spoke bisectors, as shown here by the clearance 714a between the symmetrical axle 212 and the adjacent symmetrical axle of an adjacent cross roller sub-assembly 716. In one embodiment, the chamfered sides 402 of the symmetrical axle 212 may include indentations or protrusions, rather than a uniformly flat surface. In such an embodiment, clearance 714a may not be uniform along the wheel hub spoke bisector 702a, but adjacent chamfered sides 402 may exhibit a symmetrical, mirrored clearance profile.

FIG. 8 illustrates a routine 800 for manufacturing an omnidirectional wheel 200a in accordance with one embodiment. Although the example routine 800 depicts a particular sequence of operations, the sequence may be altered without departing from the scope of the present disclosure. For example, some of the operations depicted may be performed in parallel or in a different sequence that does not materially affect the function of the routine 800. In other examples, different components of an example device or system that implements the routine 800 may perform functions at substantially the same time or in a specific sequence.

According to some examples, the method includes providing a plurality of pre-roller assemblies, such as the pre-roller assemblies 210 introduced in FIG. 2A, at block 802. Each pre-roller assembly may include a symmetrical axle and an axle bushing, such as the symmetrical axle 212 and axle bushing 214 previously described. The symmetrical axles may be injection molded from plastic materials or may be formed from metal. They may have a chamfered side on each end. Each symmetrical axle may be oriented with each chamfered side aligned with a wheel hub spoke bisector of the overmolded wheel hub formed as described with respect to FIG. 7B. Each chamfered side may be spaced the same distance from the wheel hub spoke bisector as the chamfered side of an adjacent symmetrical axle of an adjacent cross roller sub-assembly. Each axle bushing may be configured to receive one symmetrical axle in a central longitudinal bore. The axle bushings may be injection molded with an inside diameter of the central longitudinal bore being slightly larger than the diameter of the symmetrical axles. The axle bushings may have a cylindrical outer diameter in one embodiment. The axle bushings may have a spherical outer diameter in one embodiment.

Alignment features may be provided on the symmetrical axles and/or the axle bushings that permit free rotation of the axle bushings with respect to the symmetrical axles, but maintain both components with their axes of rotation colinear, as described with respect to FIG. 7B. Alignment features may also maintain the symmetrical axles and axle bushings centered with respect to a cross roller sub-assembly midline as shown in FIG. 7B. If the manufacturing process involves next forming the cross roller sub-assemblies, as indicated at decision block 804, the routine 800 may proceed to block 806. Otherwise, the routine 800 may proceed to block 812. According to some examples, the method includes overmolding each axle bushing of the pre-roller assemblies with a peripheral roller to form cross roller sub-assemblies at block 806, such as the peripheral rollers 216 and cross roller sub-assemblies 208 introduced with respect to FIG. 2A.

According to some examples, the method includes placing each cross roller sub-assembly in a mold configured to form a peripheral axle ring adapted about the wheel and radially spaced from a main axis at block 808. According to some examples, the method includes overmolding at least a portion of the cross roller sub-assemblies in the mold with a wheel hub, such as the wheel hub 202 of FIG. 2A, to form the peripheral axle ring at block 810. The wheel hub may include a main axle bore rotatable around the main axis. The wheel hub may comprise a number of spokes. Each cross roller sub-assembly may be secured between two spokes of the overmolded wheel hub. The wheel hub may comprise an inner wheel hub and an outer wheel hub, such as the inner wheel hub 218 and outer wheel hub 220 illustrated in FIG. 2A. The inner wheel hub may be pre-produced, such as the inner wheel hub 218 introduced in FIG. 2A, and may be placed in the mold with the cross roller sub-assemblies in block 808. The inner wheel hub and the symmetrical axles of the cross roller sub-assemblies may both then be overmolded with the outer wheel hub to form the wheel hub in block 810. Shut-off regions such as those described with respect to FIG. 6A-FIG. 6D may be provided in the mold. Overmolding material may thereby be prevented from interfering with at least one of the plurality of symmetrical axles, the plurality of axle bushings, and the plurality of peripheral rollers of the cross roller sub-assemblies.

According to some examples, the method includes placing each pre-roller assembly in a mold configured to form a peripheral axle ring adapted about the wheel and radially spaced from a main axis at block 812. This may be performed before the peripheral rollers are molded onto the pre-roller assemblies to form the cross roller sub-assemblies.

According to some examples, the method includes overmolding the symmetrical axles of the pre-roller assemblies in the mold with a wheel hub to form the pre-roller peripheral axle ring at block 814. The wheel hub may include a main axle bore rotatable around the main axis. The wheel hub may comprise a number of spokes. Each pre-roller assembly may be secured between two spokes of the overmolded wheel hub. The wheel hub may comprise an inner wheel hub and an outer wheel hub. The inner wheel hub may be pre-produced, such as the inner wheel hub 218 introduced in FIG. 2A, and may be placed in the mold with the pre-roller assemblies at block 812. The inner wheel hub and the symmetrical axles of the pre-roller assemblies may both then be overmolded with the outer wheel hub to form the wheel hub in block 814. First shut-off regions, such as the first shut-off regions 620 described with respect to FIG. 6C, may be provided in the mold, thereby preventing the overmolding material from interfering with at least one of the plurality of symmetrical axles, and the plurality of axle bushings of the pre-roller assemblies.

According to some examples, the method includes placing the pre-roller peripheral axle ring and overmolded wheel hub in a mold configured to form peripheral rollers at block 816. According to some examples, the method includes overmolding each axle bushing of the pre-roller assemblies with a peripheral roller to form cross roller sub-assemblies at block 818. Second shut-off regions, such as the second shut-off regions 624 described with respect to FIG. 6D, may be provided in the mold for overmolding each axle bushing of the plurality of pre-roller assemblies with the peripheral roller.

FIG. 9 illustrates exemplary omnidirectional wheel configurations 900 in accordance with one embodiment. The exemplary omnidirectional wheel configurations 900 may include a double omnidirectional wheel 902, similar to a Rotacaster R2 wheel, and a triple omnidirectional wheel 904, similar to a Rotacaster R3 wheel, and wheel brackets 906 for each configuration. An isometric view 908, a side elevation view 910, a front elevation view 912, and a plan view of the wheel bracket 914 are shown for each of the exemplary omnidirectional wheel configurations 900.

The exemplary omnidirectional wheel configurations 900 may have several steel mounts available for each example. These wheels may be manufactured with a slimmer profile than is possible when using plastic. This may make them easier to nest and may improve nesting density for nestable equipment using the omnidirectional wheels 200a. One downside to using this type of wheel is that they may need additional assembly and hardware to attach them to the cart deck using the wheel brackets 906.

FIG. 10A-FIG. 10C illustrate omnidirectional wheel configuration cross sections 1000 in accordance with one embodiment. FIG. 10A shows an omnidirectional wheel 200a in cross-section, FIG. 10B shows two omnidirectional wheels 200a assembled as a double omnidirectional wheel 902 in cross-section, and FIG. 10C shows three omnidirectional wheels 200a assembled as a triple omnidirectional wheel 904 in cross-section.

In one embodiment, the inner wheel hub 218 of the omnidirectional wheel 200a may have a smooth side 1002 and a raised side 1004. When assembled to form the double omnidirectional wheel 902, the smooth sides 1002 of the two wheels may face each other as shown in FIG. 10B, with both outer-facing sides of the joined wheels being their raised sides 1004. In one embodiment, wheels having two smooth sides 1002 may be configured between wheels having outer-facing raised sides 1004 as shown in FIG. 10C. One of ordinary skill in the art will readily apprehend that the two wheels of the double omnidirectional wheel 902 and the three wheels of the triple omnidirectional wheel 904 may all have one smooth side 1002 and one raised side 1004, oriented all right-facing, all left-facing, or any combination thereof, or may have interlocking features that support solid and steady contact among the wheels, preventing independent in-line motion 302 of any wheel with respect to the others.

As shown in FIG. 10B and FIG. 10C, omnidirectional wheels 200a placed side by side to form the double omnidirectional wheel 902 and the triple omnidirectional wheel 904 may be rotated with respect to each other so as to align the cross roller sub-assembly midlines of one omnidirectional wheel 200a with the wheel hub spoke bisectors between cross roller sub-assemblies 208 of the adjacent omnidirectional wheel 200a, such that the circumferences of the double omnidirectional wheel 902 and the triple omnidirectional wheel 904 contain no gaps between cross roller sub-assemblies 208 in contact with a surface of motion (e.g., floor or ground surface), supporting case of transverse motion 304 of the omnidirectional wheel as shown in FIG. 3. For example, with omnidirectional wheels 200a having twelve cross roller sub-assemblies 208, a rotation of 15 degrees from one omnidirectional wheel 200a to the next omnidirectional wheel 200a may allow the peripheral rollers of one wheel to be centered in the gaps between peripheral rollers of the next wheel, providing an overall circumference with no gaps between cross roller sub-assemblies 208.

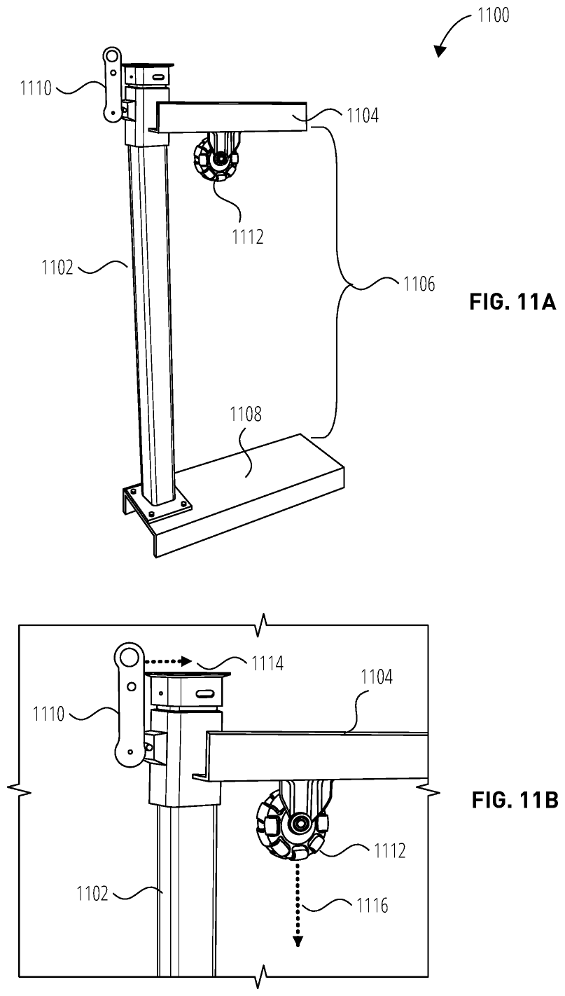

FIG. 11A and FIG. 11B illustrate an omnidirectional wheel in a drop test rig 1100 in accordance with one embodiment. The test rig 1102 may maintain a test bracket 1104 at a test drop height 1106 above a test rig base 1108 until a test bracket release 1110 is activated. A wheel assembly 1112 may be attached to the test bracket 1104 to undergo drop testing. The impact forces applied to the wheel assembly 1112 may be varied by adjusting the test drop height 1106 or by applying weights to the test bracket 1104, as will be readily understood by one of ordinary skill in the art.

FIG. 11B provides a detailed view of the wheel in the drop test rig. When the test bracket release 1110 is pushed 1114 or otherwise activated, the test bracket 1104 and wheel assembly 1112 drop 1116, impacting the test rig base 1108 with gravity-induced forces determined by the test drop height 1106 and the weight of the test bracket 1104.

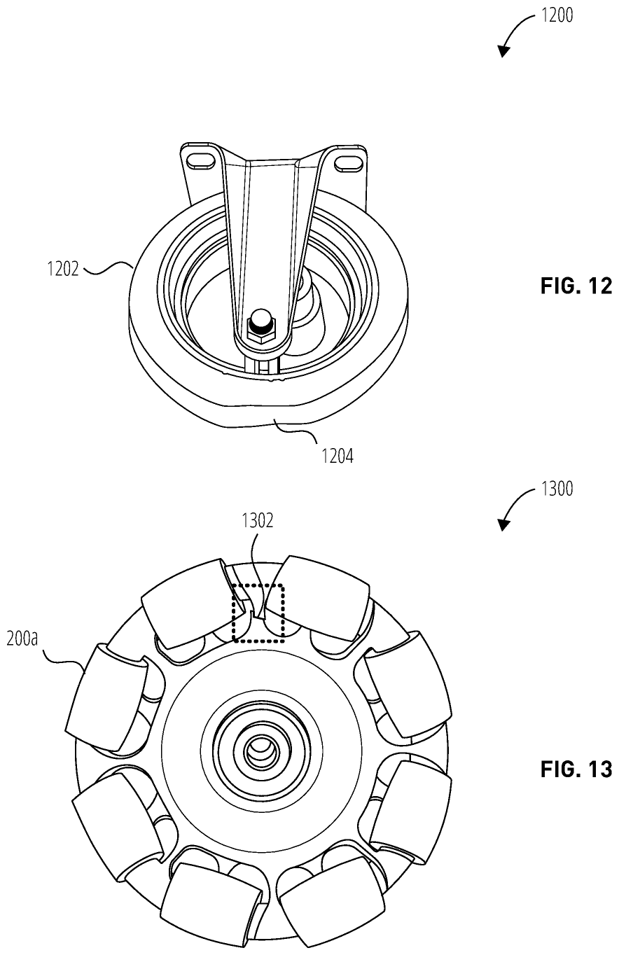

FIG. 12 illustrates drop test results for a conventional wheel 1200. The drop tests were performed using the omnidirectional wheel in a drop test rig 1100 illustrated in FIG. 11A and FIG. 11B. On the first test, after a drop from the test height, the conventional wheel 1202 bounced on its resilient tire and did not suffer any visual damage. However, on rotating it, minor bearing damage could be detected. On the second test, with approximately 25 KN of force applied, the wheel plate failed, and the damage 1204 rendered the conventional wheel 1202 completely unusable.

FIG. 13 illustrates drop test results for an omnidirectional wheel 1300 in accordance with one embodiment. The drop tests were performed using the omnidirectional wheel in a drop test rig 1100 illustrated in FIG. 11A and FIG. 11B. After three drops from the test height with 50 KN of force, the omnidirectional wheel 200a was still operational with some light damage 1302, as indicated in FIG. 13.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. Thus, an entity described or recited as “configured to” perform some task refers to something physical. The term “configured to” is not intended to mean “configurable to.” Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of this disclosure as claimed. The scope of disclosed subject matter is not limited to the depicted embodiments but is rather set forth in the following Claims.

What is claimed is:

1. A wheel comprising:
a wheel hub including a main axle bore rotatable around a main axis;
a plurality of cross roller sub-assemblies comprising:
a plurality of pre-roller assemblies including:
a plurality of symmetrical axles; and
a plurality of axle bushings, each axle bushing configured to receive one symmetrical axle in a central longitudinal bore; and
a plurality of peripheral rollers, each pre-roller assembly overmolded with one peripheral roller;
a peripheral axle ring adapted about the wheel and radially spaced from the main axis, the wheel having the plurality of cross roller sub-assemblies overmolded with the wheel hub,
wherein the overmolded cross roller sub-assemblies form the peripheral axle ring.

2. The wheel of claim 1, wherein the wheel hub comprises an inner wheel hub and an outer wheel hub, wherein the inner wheel hub is overmolded with the outer wheel hub.

3. The wheel of claim 1, wherein the overmolded wheel hub comprises a plurality of spokes, and each cross roller sub-assembly is secured between two spokes of the overmolded wheel hub.

4. The wheel of claim 1, wherein the symmetrical axles have a chamfered side on each end.

5. The wheel of claim 4, wherein the overmolded wheel hub comprises a plurality of spokes, and each cross roller sub-assembly is secured between two spokes of the overmolded wheel hub, and
wherein each symmetrical axle is oriented with each chamfered side aligned with a wheel hub spoke bisector, and
wherein each chamfered side is spaced the same distance from the wheel hub spoke bisector as the chamfered side of an adjacent symmetrical axle of an adjacent cross roller sub-assembly.

6. The wheel of claim 1, wherein the plurality of axle bushings each have a cylindrical outer diameter.

7. The wheel of claim 1, wherein the plurality of axle bushings each have a spherical outer diameter.

8. The wheel of claim 1, wherein the symmetrical axles are cross rolling pins.

9. The wheel of claim 1, wherein the symmetrical axles are made of at least one of metal and plastic materials.

10. The wheel of claim 1, wherein shut-off regions are presented during the overmolding of the plurality of cross roller sub-assemblies with the wheel hub such that an overmolding material does not interfere with at least one of the plurality of symmetrical axles, the plurality of axle bushings, and the plurality of peripheral rollers of the cross roller sub-assemblies.

11. A method of assembling a wheel, the method comprising:
providing:
a plurality of pre-roller assemblies including:
a plurality of symmetrical axles; and
a plurality of axle bushings, each axle bushing configured to receive one symmetrical axle in a central longitudinal bore;
overmolding each axle bushing of the plurality of pre-roller assemblies with a peripheral roller to form a plurality of cross roller sub-assemblies;
on condition the cross roller sub-assemblies have been formed:
placing, in a mold, each cross roller sub-assembly, the mold configured to form a peripheral axle ring adapted about the wheel and radially spaced from a main axis; and
overmolding at least a portion of the cross roller sub-assemblies in the mold with a wheel hub to form the peripheral axle ring, wherein the wheel hub includes a main axle bore rotatable around the main axis;
on condition the cross roller sub-assemblies have not been formed:
placing, in the mold, each pre-roller assembly, the mold configured to form a pre-roller peripheral axle ring adapted about the wheel and radially spaced from the main axis; and
overmolding the symmetrical axles of the pre-roller assemblies in the mold with the wheel hub to form the pre-roller peripheral axle ring, wherein the wheel hub includes the main axle bore rotatable around the main axis.

12. The method of claim 11, wherein the overmolding of each pre-roller assembly with the peripheral roller occurs after the overmolding of the symmetrical axles of the pre-roller assemblies.

13. The method of claim 11, wherein the wheel hub comprises an inner wheel hub and an outer wheel hub, the method further comprising:
placing the inner wheel hub in the mold with the cross roller sub-assemblies;
overmolding the inner wheel hub and the symmetrical axles of the cross roller sub-assemblies with the outer wheel hub.

14. The method of claim 11, further comprising:
providing shut-off regions in the mold, for the overmolding of at least portions of the cross roller sub-assemblies in the mold, with the wheel hub, to form the peripheral axle ring, wherein an overmolding material does not interfere with at least one of the plurality of symmetrical axles, the plurality of axle bushings, and the plurality of peripheral rollers of the cross roller sub-assemblies.

15. The method of claim 11, further comprising:
providing first shut-off regions in the mold, for overmolding of the symmetrical axles of the pre-roller assemblies with the wheel hub, wherein an overmolding material does not interfere with at least one of the plurality of symmetrical axles, and the plurality of axle bushings of the pre-roller assemblies, and
providing second shut-off regions in the mold, for overmolding each axle bushing of the plurality of pre-roller assemblies with the peripheral roller,
wherein the overmolding of each axle bushing of the plurality of pre-roller assemblies with the peripheral roller occurs after the overmolding of the symmetrical axles with the wheel hub.

16. The method of claim 11, wherein the overmolded wheel hub comprises a plurality of spokes and each cross roller sub-assembly is secured between two spokes of the overmolded wheel hub.

17. The method of claim 16, wherein the symmetrical axles have a chamfered side on each end, the method further comprising:
orienting each symmetrical axle with each chamfered side aligned with a wheel hub spoke bisector; and
spacing each chamfered side the same distance from the wheel hub spoke bisector as the chamfered side of an adjacent symmetrical axle of an adjacent cross roller sub-assembly.

18. The method of claim 11, further comprising injection molding the plurality of axle bushings with an inside diameter slightly larger than the symmetrical axles, each axle bushing having a cylindrical outer diameter.

19. The method of claim 11, further comprising injection molding the plurality of axle bushings with an inside diameter slightly larger than the symmetrical axles, each axle bushing having a spherical outer diameter.

20. The method of claim 11, further comprising injection molding the symmetrical axles with a chamfered side on each end.
